(19) United States
(12) Patent Application Publication
(10) Pub. No.: US 2015/0215863 A1
(43) Pub. Date: Jul. 30, 2015

(54) NETWORK CARD DEVICE, ROUTING DEVICE, SYSTEM AND METHOD FOR REALIZING DYNAMIC SLEEP AND WAKEUP

(71) Applicant: ZTE Corporation, Shenzhen (CN)

(72) Inventors: Zhenkun Yuan, Shenzhen (CN); Haitao Zhao, Shenzhen (CN)

(21) Appl. No.: 14/422,715

(22) PCT Filed: Jul. 22, 2013
(86) PCT No.: PCT/CN2013/079787

§ 371 Date: Feb. 20, 2015

(30) Foreign Application Priority Data
Aug. 21, 2012 (CN) 201210299145.7

(51) Int. Cl. H04W 52/02; H04W 48/16

(52) U.S. Cl. CPC H04W 52/0206; H04W 48/16

(57) ABSTRACT

Disclosed is a network card device for realizing dynamic sleep and wakeup, for determining that a routing device has entered into a sleep mode or a quasi-power-off mode when no WiFi signal of the routing device is found, and sending automatic wake-up/power-on command to the routing device. Also disclosed is a routing device, for being woken up from a sleep mode to a normal mode or powered on and recovered from a quasi-power-off mode to the normal mode according to an automatic wake-up/power-on command. Also disclosed is a system composed of the above two devices. Also disclosed is a method for, when a user requests to access a routing device which has entered into a sleep mode or a quasi-power-off mode, being woken up from a sleep mode to a normal mode or powered on and recovered from the quasi-power-off mode to the normal mode according to automatic wake-up/power-on command.

### TECHNICAL FIELD

The present invention relates to the technical field of mobile radio communication system, and more particularly, to a network card device, routing device, system and method for realizing dynamic sleep and wakeup.

### BACKGROUND OF THE INVENTION

With the widespread use of the Internet in people's lives, as well as the large-scale application of third-generation and even upgraded mobile network technologies, portable wireless routers gradually enter into people's lives and provide people with more convenient wireless Internet access mode. Because the features that the portable wireless router is compact, portable, and can provide access of the Internet anytime and anywhere, a wireless network card combining with a portable wireless router has become an Internet access medium which is increasingly popular in users. It can be expected that, with the development of mobile network technology, network bandwidth continuously increases, network coverage is more and more optimized, and usage rate is more and more attractive, and this mode will become a mainstream mode of Internet access.

Based on the consideration of reducing power consumption and increasing the life time, the design of the existing portable wireless router uses the following method process, as shown in FIG. 1, it comprises:

In step 101, the portable wireless router is powered on and is in the power-on state.

In Step 102, when there is user access, the portable wireless router remains in the normal mode, and the portable wireless router in the normal mode maintains the maximal power consumption.

In Step 103, when there is no user access, it is to judge whether the duration of no user access is greater than T (e.g., 10 minutes) or not, if yes, it is to proceed to step 104; otherwise, it is to proceed to step 102.

In Step 104, it is to enter into the sleep mode. After entering into the sleep mode, the router is in the power saving state, and the power consumption is much lower than that in the normal mode.

Herein, the portable wireless router in the sleep mode needs to continue monitoring the mobile network channel and maintaining the mobile network attachment and update.

In Step 105, it is to judge whether there is user access or not, if yes, it is to proceed to step 106; otherwise, it is to proceed to step 104.

In Step 106, when the user needs to re-access the portable wireless router via the wireless network card, the portable wireless router in the sleep mode needs to be woken up by the user by manually pressing keys to access successfully.

In Step 107, it is to enter into the normal mode, and the re-access is successful.

With the abovementioned existing design, the power consumption is relatively high in the normal mode, which reduces the battery life of the portable wireless router, and the battery life is short, and for this, the sleep mode is introduced. After entering into the Sleep mode, the wifi is powered off, and the wireless router maintains low-power operation, for example, the current of portable wireless router products from Huawei and other mainstream manufacturers is about 10 mA in the sleep mode.

However, in the sleep mode, the terminal still needs to monitor the channel and maintain the network attachment and update, in some scenes, especially in cases that the mobile network environment is not good, in order to maintaining the RF transmit power, the power consumption is far beyond the ideal value, which is one of the important reasons about why in the actual use, the actual standby time is much less than the theoretical standby time. Moreover, after the sleep mechanism is introduced, although the battery life is greatly increased, it brings some inconveniences to the user for using. If the portable wireless router is just in the sleep mode when the user accesses, because the wifi is powered off at this time, the wireless network card is unable to find and access wifi signals, therefore the user needs to wake up the portable wireless router through manual operation, for example, only after the portable wireless router is woken up by manually key-pressing, can the user access the wifi.

In summary, the current portable wireless routing system automatically enters into the sleep mode to achieve the purpose of reducing power consumption and increasing the battery life after being in the state of no user access for a certain duration. However when the user needs to access a portable wireless router in the sleep state, the user first needs to manually press the keys to wake up the portable wireless router in order to access the wifi, it can be seen that, using the existing technical solution has the following problems:

1. The portable wireless router automatically sleeps based on the usage. A terminal in the sleep mode needs to monitor the channel in order to maintain the mobile network attachment and updates since the firmware body is still running. This still needs to consume energy, in practical usage, and especially in some cases that the mobile network environment is not good, the power consumption is still relatively high.

2. The wakeup of the portable wireless router in the sleep mode is totally dependent on human intervention, and at each time it is always required to manually pressing the key to wake up the router, which on one hand is inconvenient for the user to use, and on the other hand is easy to wear the keys, cause physical damages on the keys, and reduce their service life. It is especially prominent in the following usage scenarios, for example, due to specific needs, the user needs to use the router discontinuously, but if the time interval exceeds a triggering time for entering into sleep, it leads to that the user needs to manually press the keys repeatedly to wake up the router.

### SUMMARY OF THE INVENTION

In view of this, the main purpose of the embodiment of the present invention is to provide a network card device, routing device, system and method for realizing dynamic sleep and wakeup, to reduce power consumption and increase battery life, and manually key-pressing is not required for waking up.

To achieve the abovementioned purpose, the technical solution of the embodiment of the present invention is achieved as:

a network card device for realizing dynamic sleep and wakeup, wherein the network card device is configured to initiate searching and accessing for wifi signals, and determine that a routing device has entered into a sleep mode or a quasi-power-off mode when no wifi signal of the routing device is found, and send an automatic wake-up/power-on command to the routing device.

Wherein, the network card device specifically comprises: a network card master control module and a transmission module; wherein,

the network card master control module is configured to initiate searching and accessing for wifi signals, and call and power on the transmission module when determining that the routing device has entered into the sleep mode or the quasi-power-off mode;

the transmission module is configured to transmit the automatic wake-up/power-on command after called and powered on by the network card master control module.

Wherein, the network card master control module is further configured to call and power off the transmission module after the routing device is woken up from the sleep mode to return to a normal mode or is recovered from the quasi-power-off mode to the normal mode and successfully accesses the wifi signals;

the transmission module is further configured to be called and powered off by the network card master control module.

A routing device for realizing dynamic sleep and wakeup, wherein the routing device is configured to select to enter into a sleep mode or a quasi-power-off mode according to an actual user access and traffic situation; when a user requests to access the routing device which has entered into the sleep mode or the quasi-power-off mode, receive an automatic wake-up/power-on command sent by a network card device, to be woken up from the sleep mode to return to a normal mode, or be powered on and recovered from the quasi-power-off mode to return to the normal mode.

Wherein, the routing device specifically comprises: a master control module, and a reception processing module; wherein,

the master control module is configured to call and power on the reception processing module in a case that the routing device is in the sleep mode or the quasi-power-off mode; after the reception processing module receives the automatic wake-up/power-on command, wake up the routing device from the sleep mode to return to the normal mode, or power on and recover the routing device from the quasi-power-off mode to return to the normal mode;

the reception processing module is configured to receive the automatic wake-up/power-on command transmitted by a transmission module after called and powered on by the master control module.

Wherein, the master control module is further configured to call and power off the reception processing module after the routing device returns to the normal mode;

the reception processing module is further configured to be called and powered off by the master control module.

Wherein, the master control module is further configured to perform inactivity detection regularly according to a predetermined time, and control the routing device to enter into the sleep mode or the quasi-power-off mode.

A system for implementing dynamic sleep and wakeup, wherein the system comprises: a network card device, and a routing device; wherein,

the network card device is configured to initiate searching and accessing for wifi signals, determine that the routing device has entered into a sleep mode or a quasi-power-off mode when no wifi signals of the routing device is found, and send an automatic wake-up/power-on command to the routing device;

the routing device is configured to select to enter into the sleep mode or the quasi-power-off mode according to an actual user access and traffic situation; when a user requests to access a routing device which has entered into the sleep mode or the quasi-power-off mode, receive the automatic wake-up/power-on command sent by the network card device, and to be woken up from the sleep mode to return to a normal mode or be powered on and recovered from the quasi-power-off mode to return to the normal mode.

Wherein the network card device specifically comprises: a network card master control module, a transmit module; the routing device specifically comprises: a master control module, and a reception processing module; wherein,

the network card master control module is configured to initiate searching and accessing for the wifi signals, and call and power on the transmission module when determining that the routing device has entered into the sleep mode or the quasi-power-off mode;

the transmission module is configured to transmit the automatic wake-up/power-on command after called and powered on by the network card master control module;

the master control module is configured to call and power on the reception processing module in a case that the routing device is in the sleep mode or the quasi-power-off mode; after the reception processing module receives the automatic wake-up/power-on command, wake up the routing device from the sleep mode to return to the normal mode, or power on and recover the routing device from the quasi-power-off mode to return to the normal mode;

the reception processing module is configured to receive the automatic wake-up/power-on command transmitted by the transmission module after called and powered on by the master control module.

Wherein, the network card master control module is further configured to call and power off the transmission module after the routing device is woken up from the sleep mode to return to the normal mode or is recovered from the quasi-power-off mode to the normal mode to successfully access the wifi signals;

the transmission module is further configured to be called and powered off by the network card master control module;

the master control module is further configured to call and power off the reception processing module after the routing device returns to the normal mode;

the reception processing module is further configured to be called and powered off by the master control module.

A method for implementing dynamic sleep and wakeup, wherein the method comprises:

selecting to enter into a sleep mode or a quasi-power-off mode according to an actual user access and traffic situation;

when a user requests to access a routing device which has entered into the sleep mode or the quasi-power-off mode, the routing device being woken up from the sleep mode to return to a normal mode or being powered on and recovered from the quasi-power-off mode to return to the normal mode according to an automatic wake-up/power-on command.

Wherein, selecting the sleep mode or the quasi-power-off mode according to the actual user access and traffic situation specially comprises:

when there is no user access, or there is user access but there is no traffic, determining that the routing device is in an inactivity state;

when a duration of the inactivity state matches with a preset first detection time T1, selecting to enter into the sleep mode;

when a duration of the sleep mode matches with a preset second detection time T2, selecting to enter into the quasi-power-off mode.

Wherein, returning to the normal mode based on the user request and according to the automatic wake-up/power-on command specifically comprises:

a network card device searching for and detecting wifi signals of the routing device, if no wifi signal is detected, sending the automatic wake-up/power-on command to the routing device;

the routing device being woken up from the sleep mode to return to the normal mode or being powered on and recovered from the quasi-power-off mode to return to the normal mode according to the received automatic wake-up/power-on command.

In the embodiment of the present invention, it is to select to enter into the sleep mode or the quasi-power-off mode based on the actual user access and traffic situation; when a user requests to access a routing device which has entered into the sleep mode or the quasi-power-off mode, according to the automatic wake-up/power-on command, the routing device is woken up from the sleep mode to return to the normal mode, or is powered on and recovered from the quasi-power-off mode to return to the normal mode.

With the embodiment of the present invention, in the case that there is no user access or no actual usage traffic, the wireless routing device can select to enter into the sleep mode or the quasi-power-off mode to further reduce power consumption and increase battery life; when the user re-accesses and uses the wireless routing device, the device is automatically woken up or powered on according to the automatic wake-up/power-on command, and no user intervention user is required, thereby improving convenience of user operation.

### BRIEF DESCRIPTION OF THE DRAWINGS

FIG. 1 is a schematic diagram of mode transition and access of a conventional portable wireless router;

FIG. 2 is a schematic diagram of a composition structure of a system in accordance with an embodiment of the present invention;

FIG. 3 is a schematic diagram of a composition structure of a system comprising a routing device sub-module in accordance with an embodiment of the present invention;

FIG. 4 is a flow chart of a method corresponding to the system in accordance with an embodiment of the present invention.

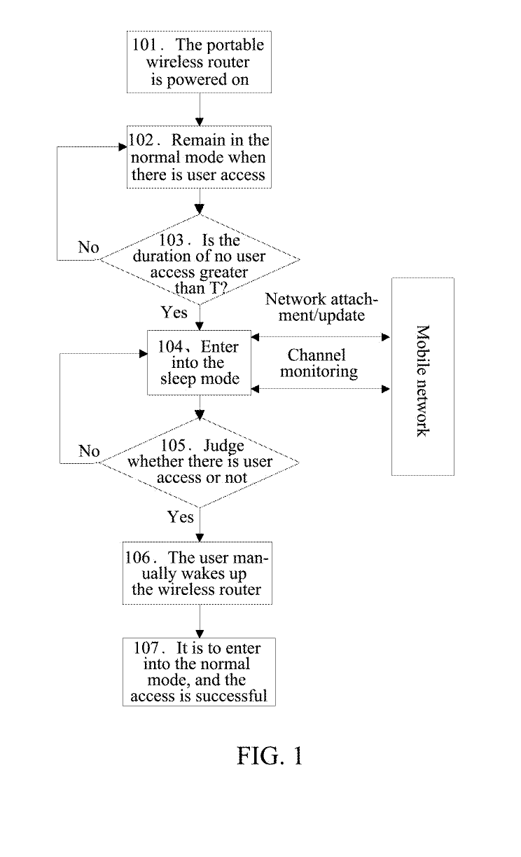

### PREFERRED EMBODIMENTS OF THE INVENTION

In the embodiment of the present invention, according to the actual user access and traffic situation, it is to select to enter the sleep mode or the quasi-power-off mode; when a user requests to access a routing device which has entered into the sleep mode or the quasi-power-off mode, according to the automatic wake-up/power-on command, the routing device is woken up from the sleep mode to return to the normal mode or is powered on and recovered from the quasi-power-off mode to return to the normal mode.

The embodiment of the present invention mainly comprises the following contents:

aiming to the problem in the prior art that, after the introduction of sleep mechanism, the portable wireless router automatically enters into the sleep mode and still has high power consumption after it is in a no user access state for a certain duration, and from the aspect of further reducing power consumption and increasing the battery life, the embodiment of the present invention further introduces the quasi-power-off mechanism, namely, the portable wireless routing device in accordance with the embodiment of the present invention first enters into the sleep mode based on the actual user access and traffic situation, and then enters into the quasi-power-off mode from the sleep mode. That is, although the sleep mode in accordance with the embodiment of the present invention is the same as that of the conventional portable wireless router in design and realization, but the difference is, after the embodiment of the present invention introduces the quasi-power-off mode, the sleep mode exists as a transition mode of the normal mode and the introduced quasi-power-off mode, moreover, just because of the presence of the sleep mode, it is possible to switch more quickly to return to the normal mode. After entering into the quasi-power-off mode, the portable wireless routing device is powered off and there is no power consumption, it can be seen that, after the embodiment of the present invention introduces the quasi-power-off mode, there are two selectable modes, the sleep mode and the quasi-power-off mode which further reduces power consumption, to select, and different from the prior art in which there is only the sleep mode and the manual wakeup is required, with the embodiment of the present invention, power consumption can be significantly reduced, and due to the reduction in power consumption, the battery life of the portable wireless routing device can be greatly increased.

Aiming to the problem in the prior art that, after the introduction of the sleep mechanism, when the user needs to re-access, because it is in the sleep mode, the portable wireless router can only be accessed after woken up through manually key-pressing, and from the perspective of achieving automatic and convenient operation to facilitate using by the user, reduce physical wearing and increase the life of the portable wireless router, the embodiment of the present invention introduces the automatic wakeup mechanism to replace the manual human intervention mechanism. Since the wireless routing device is already in the sleep mode or further in the quasi-power-off mode, therefore, when a user requests again to re-access the portable wireless routing device, the wireless network card device first needs to search and detect, and try to access the wifi of the target portable wireless routing device, if no wifi signal is detected, then it is to power on the transmission module in the wireless network card device, and send the automatic wake-up/power-on command in the format of wireless signal to the reception processing module located in the wireless routing device, and after the reception processing module receives the automatic wake-up/power-on command, the wireless routing device is woken up from the sleep mode to return to the normal mode, or is recovered from the quasi-power-off mode to the normal mode, meanwhile, the wireless network card device continues to search the wireless routing device until wifi signals are found and the access is successful.

Specifically, the wireless routing system in accordance with the embodiment of the present invention comprises a wireless network card device and a wireless routing device. Wherein, besides of essential components of the existing wireless network card device, the wireless network card device further comprises the newly-added transmission module and network card master control module, and besides of the essential components of the existing portable wireless router, the wireless routing device further comprises the newly-added reception processing module and master control module.

When there is no any user access or there is user access but there is no any traffic, the wireless routing device will be determined as in the inactivity state (the determination is completed by the master control module, or further completed by the inactivity detection sub-module in the master control module).

After the wireless routing device remains in the inactivity state for the specific duration T1 (such as 10 minutes), it first enters into the sleep mode. It should be noted that, although there is still the sleep mode in the embodiments of the present invention, it is not used for monitoring the channel or maintaining the network attachment and update, but for providing a transition from the normal mode to the quasi-power-off mode, moreover, it can be more quickly switched back to the normal mode from the sleep mode. After the wireless routing device remains in the sleep mode for a predetermined duration T2 (such as 15 minutes), it enters into the quasi-power-off mode. In the quasi-power-off mode, the wireless routing device is powered off.

After entering into the sleep mode, the wireless routing device is in the normal sleep mode, and maintains the mobile network attachment and update, and channel monitoring. After entering into the sleep mode, the reception processing module in the wireless routing device starts to run.

After entering into the quasi-power-off mode, the wireless routing device is powered off After entering into the quasi-power-off mode, except that the reception processing module is still running, all the other modules in the wireless routing device are powered off, thereby reducing the power consumption and increasing the battery life, its principle is that, when in the quasi-power-off mode, since the wireless routing device is completely in the power-off state, there is no need to keep the firmware program running, or maintain the mobile network attachment and update, or monitor the mobile network channel, thereby reducing the power consumption and improving the battery life.

Herein, the reception processing module can use discontinuous reception technology to monitor wireless signals transmitted by the transmission module in the wireless network card device.

When a user requests to access the wireless routing device which is in the sleep or quasi-power-off mode, first the network card master control module in the wireless network card device is powered on to search for and detect wifi signals of the wireless router, if the network card master control module cannot detect any wifi signals, the wireless router is considered to be currently in the sleep mode or the quasi-power-off mode, therefore, the network card master control module powers on the transmission module, and the transmission module transmits wireless signals in which an automatic wake-up/power-on command is encapsulated to the reception processing module running in the wireless router.

When the wireless routing device is in the sleep mode or the quasi-power-off mode, it can receive the automatic wake-up/power-on command, after the reception processing module receives the automatic wake-up/power-on command and initiates a wakeup or power-on request to the master control module in the wireless routing device, the wireless routing device is woken up from the sleep mode to return to the normal mode, or is recovered from the quasi-power-off mode to the normal mode, after it is woken up or powered on successfully, the reception processing module is powered off by the master control module. In this process, the wireless network card device will continue searching for wireless signals of the wireless router, until the wifi signals are found and the access is successful, or the access times out. Subsequently, the transmission module in the wireless network card devices is powered off by the network card master control module.

In summary, the use of the network card and routing device in accordance with the embodiment of the present invention as well as the system formed thereof, and the method operation process corresponding to the system can achieve the following advantages:

1. the wireless routing device can not only enter into the sleep mode and reduce power consumption based on usage, but also automatically enter into the quasi-power-off mode to further reduce power consumption. In an actual use, especially in some poor local mobile network environments, the power-saving effect of this technology implementation is particularly evident.

2. when a user needs to re-access and use the wifi, the wakeup or power-on of the wireless routing device is automatically controlled, and no human operation is needed, thereby enhancing the convenience and ease of user operation. For example, one scenario is that, the user may only need to occasionally use the wifi, if the existing portable wireless routing system is used, every wakeup requires the user's man-made operation. Using the wireless router system in accordance with the embodiment of the present invention makes the system itself wake up or power on, and no manual operation of the user is needed, thereby improving the experience of the user operation.

3. After entering into the quasi-power-off mode, except a separate reception processing module which is running, the other parts of the wireless routing device are powered off completely, thereby preventing the wireless routing device from being powered on and running for a long time, and improving the performance and stability of the device.

In the following, the implementation of the technical solution will be described in further detail with reference to the accompanying drawings.

Taking the wireless network card device based on the 3G network, the wireless routing device, and the wireless routing system consisting thereof as an example to describe, of course, the present embodiment only takes the portable 3G wireless router for example, but is not limited to portable wireless routers in other non-3G network modes.

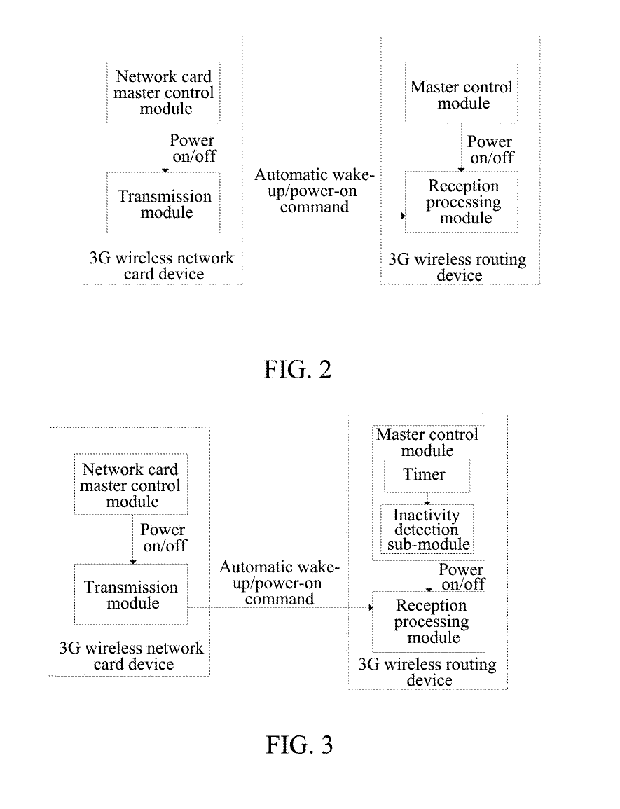

As shown in FIG. 2, the 3G wireless network card device comprises: a network card master control module and a transmission module.

Wherein, the network card master control module can run after the network card is powered on, and similar to the conventional wireless network card function module, the network card master control module is configured to initiate searching and accessing for wifi signals. If the wifi signals of the target device 3G wireless router are not found, the 3G wireless routing device is considered to be in the sleep mode or the quasi-power-off mode, therefore, the network card master control module powers on the transmission module, and sends an automatic wake-up/power-on command to the reception processing module of the 3G wireless routing device. In this process, the network card master control module will continue searching for wifi signals of the target 3G wireless routing device, until the wifi access is successful or times out.

The transmission module is configured to, after being called or powered on by the network card master control module, transmit an automatic wake-up/power-on command which is configured for waking up or powering on from the sleep mode at the request of the network card master control module. The transmission module continues to transmit wireless signals such as continuous pulse waves at a certain frequency (such as 2.4 GHz, the reason for 2.4 GHz being taken into consideration is that the existing wireless router, wireless mouse, and other devices use this frequency), until the wireless network card device successfully access the wifi signals of the target 3G wireless routing device or the wifi signal access times out, then the transmission module is powered off.

As shown in FIG. 2, the 3G wireless routing device comprises: a master control module and a reception processing module.

Wherein, the reception processing module comprises a signal receiving device to receive wireless signals (the wireless signals comprise the automatic wake-up/power-on command) transmitted by the transmission module in the wireless network card device, thereby enabling the operation of waking up or powering on the 3G wireless routing device. When the 3G wireless routing device is in the normal mode, the reception processing module is powered off, when the 3G wireless routing device is in the sleep mode or the quasi-power-off mode, the reception processing module is called and powered on by the master control module. After the reception processing module receives an automatic wake-up/power-on command sent to it, it performs a wake-up or power-on operation on the 3G wireless routing device. Herein, the reception processing module is used to perform a wakeup operation on the 3G wireless routing device, a key similar to the simulation can be used and configured to implement a wakeup or power-on operation. Since the reception processing module still needs to consume the battery power, the reception processing module can use the discontinuous-reception technology to receive the wireless signals transmitted by the transmission module in order to further reduce the power consumption and improve the battery life. Wherein, a simulated key-press example which uses the reception processing module to implement a wake-up operation on the 3G wireless routing device is specifically: for example, the reception processing module sends a signal to the power management integrated circuit (PMIC) to let the PMIC trigger a power-on event. Because what is ultimately produced by the key-press operation is a change of the level, the reception processing module inputs it to the PMIC via the change in the simulated level, so as to achieve the simulation of the key-press action.

The master control module is configured to, in the case that the 3G wireless routing device is in the sleep mode or the quasi-power-off mode, call and power on the reception processing module; after the reception processing module receives an automatic wake-up/power-on command from the transmission module, wake up the wireless routing device from the sleep mode to return to the normal mode, or power on and recover the wireless routing device from the quasi-power-off mode to the normal mode, while call and power off the reception processing module. The master control module is further configured to perform an inactivity detection regularly according to the predetermined time (such as the specific durations T1 and T2), and control the wireless routing device to enter into the sleep mode or the quasi-power-off mode. Herein, the detection executed herein is specifically as follows: in the case that the specific durations (T1, T2) are pre-configured, detecting the duration of the inactivity state and the duration of the sleep mode regularly according to the set T1 and T2, and matching with the set T1 and T2, if the matching is successful, then entering into a preset selectable mode (entering into the sleep mode when the T1 matching is satisfied, and entering into the quasi-power-off mode when the T2 matching is satisfied).

Furthermore, as shown in FIG. 3, the master control module comprises: an inactivity detection sub-module and a timer. Wherein, for the inactivity detection sub-module, when the 3G wireless routing device monitors and performs statistic on the usage, the inactivity detection sub-module is called regularly to judge whether the current state is the activity state or the inactivity state. If in the detection period, the 3G wireless routing device remains in the inactivity state, it is determined that the transition prerequisite of the sleep/quasi-power-off mode is met, and it is to report to the master control module. For the timer, the 3G wireless routing device powers on the timer, the user can pre-configure the duration (such as T1, T2) of the timer, and powers on the timer to call the inactivity detection sub-module regularly to detect whether it is currently in activity or inactivity.

As shown in FIG. 2 or 3, the 3G wireless routing system consists of the 3G wireless network card device and the 3G wireless routing device, while the description of the 3G wireless network card device and the 3G wireless routing device will not be repeated here.

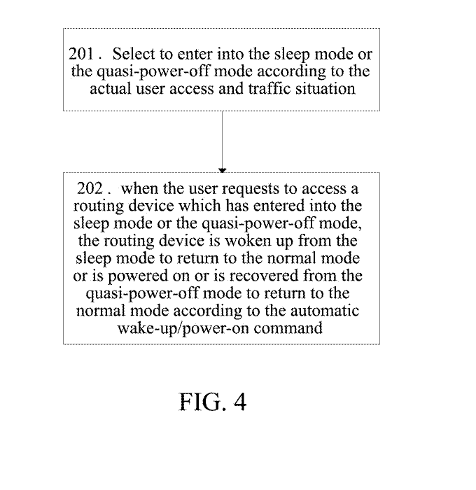

As shown in FIG. 4, the method process corresponding to the 3G wireless routing system comprises the following steps:

In step 201, it is to select to enter into the sleep mode or the quasi-power-off mode according to the actual user access and traffic situation.

In Step 202, when the user requests to access a routing device which has entered into the sleep mode or the quasi-power-off mode, the routing device is woken up from the sleep mode to return to the normal mode or is powered on or is recovered from the quasi-power-off mode to return to the normal mode according to the automatic wake-up/power-on command.

It should be noted here that: with the method process corresponding to the system in accordance with the embodiment of the present invention, the firmware system of the 3G wireless routing system automatically monitors the system activity, when the system is in the normal mode—inactivity state for a certain duration, it enters into the sleep mode; when the system is in the sleep mode—inactivity state after a certain duration, it enters into the quasi-power-off mode. When the 3G wireless routing system is in the sleep or quasi-power-off mode, and the wireless network card device tries to access the wifi, it will fail and the target wifi signals cannot be found, the wireless network card device powers on the transmission module, and sends signals to wake up the target portable 3G wireless routing device. In other words, the 3G wireless routing device selects to enter into the sleep mode or the quasi-power-off mode according to the user access or traffic situation in the actual use, the wireless network card device automatically wakes up or powers on the 3G wireless routing device again according to the operation of the user accessing the wifi signals, therefore the 3G wireless routing device can dynamically and accurately achieve the sleep (standby) and quasi-power-off, avoiding the power consumption when the device is not be used for a long time and is in the sleep mode. The “automation” of the device which has entered into the sleep/quasi-power-off mode being woken up and entering into the normal mode removes the manual operations by the user and enhances the convenience of user operation.

Herein, the operation process performed by the 3G wireless network card device in the 3G wireless routing system comprises the following contents:

a1. the user powers on the 3G wireless network card device and tries to access the wifi signals.

a2. the 3G wireless network card device searches for the target wifi signals, if the target wifi signals are found, the access is successful, it is to proceed to step a5; if the target wifi signals cannot be found, the target 3G wireless routing device is considered to be in the sleep mode or the quasi-power-off state, and the transmission module is powered on.

a3. the transmission module transmits wireless signals to the target 3G wireless routing device.

a4. the 3G wireless network card device keeps trying until the wifi access is successful, and the transmission module is powered off. Otherwise the access times out and the transmission module is powered off

a5. the process ends.

Herein, the operation process performed by the 3G wireless routing device in the 3G wireless routing system comprises the following contents:

b1. after the 3G wireless routing device is powered on, it first enters into the normal mode.

b2. the master control module detects whether the system is in activity or inactivity.

b3. if the master control module detects that the 3G wireless routing device is always in the inactivity state in the specific duration T1, the reception processing module is powered on and the 3G wireless routing device enters into the sleep mode; otherwise it is to return back to step b1. In the sleep mode, the 3G wireless routing device needs to continuously monitor the channel and maintain the mobile network attachment and update.

b4. if the 3G wireless routing device receives an automatic wake-up command sent by the 3G wireless network card device in the sleep mode, it is to proceed to step b7, otherwise the routing device remains in the sleep state.

b5. if the duration of the sleep mode is longer than the specific duration T2, then the 3G wireless routing device enters into the quasi-power-off mode. After entering into the quasi-power-off mode, the reception processing module keeps running, and the 3G wireless routing device is powered off.

b6. in the quasi-power-off mode, if the 3G wireless routing device receives an automatic power-on command sent by the 3G wireless network card device, it is to proceed to step b7, otherwise the routing device remains in the quasi-power-off mode.

b7. the reception processing module is powered off, and the 3G wireless routing device enters into the normal mode.

The above description is only for preferred embodiments of the present invention and is not intended to limit the protection scope of the present invention.

### INDUSTRIAL APPLICABILITY

In the embodiment of the present invention, it is to select to enter into the sleep mode or the quasi-power-off mode according to the actual user access and traffic situation; when a user requests to access a routing device which has entered into the sleep mode or the quasi-power-off mode, according to the automatic wake-up/power-on command, the routing device is woken up from the sleep mode to return to the normal mode, or is powered on and recovered from the quasi-power-off mode to return to the normal mode. With the embodiment of the present invention, in the case that there is no user access or no actual usage traffic, the wireless routing device can select to enter into the sleep mode or the quasi-power-off mode to further reduce power consumption and increase battery life; when the user re-accesses and uses the wireless routing device, the device is automatically woken up or powered on according to the automatic wake-up/power-on command, and no user intervention is required, thereby improving convenience of user operation.

1. A network card device for realizing dynamic sleep and wakeup, wherein, the network card device is configured to initiate searching and accessing for wifi signals, and determine, when no wifi signal of a routing device is found, that the routing device has entered into a sleep mode or a quasi-power-off mode, and send an automatic wake-up/power-on command to the routing device.

2. The device of claim 1, wherein, the network card device specifically comprises: a network card master control module and a transmission module; wherein,
the network card master control module is configured to initiate searching and accessing for wifi signals, and call and power on the transmission module when determining that the routing device has entered into the sleep mode or the quasi-power-off mode;
the transmission module is configured to transmit the automatic wake-up/power-on command after called and powered on by the network card master control module.

3. The device of claim 2, wherein, the network card master control module is further configured to call and power off the transmission module after the routing device is woken up from the sleep mode to return to a normal mode or is recovered from the quasi-power-off mode to the normal mode and successfully accesses the wifi signals;
the transmission module is further configured to be called and powered off by the network card master control module.

4. A routing device for realizing dynamic sleep and wakeup, wherein the routing device is configured to select to enter into a sleep mode or a quasi-power-off mode according to an actual user access and traffic situation; when a user requests to access the routing device which has entered into the sleep mode or the quasi-power-off mode, receive an automatic wake-up/power-on command sent by a network card device, to be woken up from the sleep mode to return to a normal mode, or be powered on and recovered from the quasi-power-off mode to return to the normal mode.

5. The device of claim 4, wherein, the routing device specifically comprises: a master control module and a reception processing module; wherein,
the master control module is configured to call and power on the reception processing module in a case that the routing device is in the sleep mode or the quasi-power-off mode; after the reception processing module receives the automatic wake-up/power-on command, wake up the routing device from the sleep mode to return to the normal mode, or power on and recover the routing device from the quasi-power-off mode to return to the normal mode;
the reception processing module is configured to receive the automatic wake-up/power-on command transmitted by the transmission module after called and powered on by the master control module.

6. The device of claim 5, wherein, the master control module is further configured to call and power off the reception processing module after the routing device returns to the normal mode;
the reception processing module is further configured to be called and powered off by the master control module.

7. The device of claim 5, wherein, the master control module is further configured to perform an inactivity detection regularly according to a predetermined time, and control the routing device to enter into the sleep mode or the quasi-power-off mode.

8. A system for implementing dynamic sleep and wakeup, wherein the system comprises: a network card device and a routing device; wherein,
the network card device is configured to initiate searching and accessing for wifi signals, determine, when no wifi signal of a routing device is found, that the routing device has entered into a sleep mode or a quasi-power-off mode, and send an automatic wake-up/power-on command to the routing device;
the routing device is configured to select to enter into the sleep mode or the quasi-power-off mode according to an actual user access and traffic situation; when a user requests to access a routing device which has entered into the sleep mode or the quasi-power-off mode, receive the automatic wake-up/power-on command sent by the network card device, and to be woken up from the sleep mode to return to a normal mode or be powered on and recovered from the quasi-power-off mode to return to the normal mode.

9. The system of claim 8, wherein the network card device specifically comprises: a network card master control module and a transmit module; the routing device specifically comprises: a master control module and a reception processing module; wherein,
the network card master control module is configured to initiate searching and accessing for the wifi signals, and call and power on the transmission module when determining that the routing device has entered into the sleep mode or the quasi-power-off mode;
the transmission module is configured to transmit the automatic wake-up/power-on command after called and powered on by the network card master control module;
the master control module is configured to call and power on the reception processing module in a case that the routing device is in the sleep mode or the quasi-power-off mode; after the reception processing module receives the automatic wake-up/power-on command, wake up the routing device from the sleep mode to return to the normal mode, or power on and recover the routing device from the quasi-power-off mode to return to the normal mode;
the reception processing module is configured to receive the automatic wake-up/power-on command transmitted by the transmission module after called and powered on by the master control module.

10. The system of claim 9, wherein, the network card master control module is further configured to call and power off the transmission module after the routing device is woken up from the sleep mode to return to the normal mode or is recovered from the quasi-power-off mode to the normal mode to successfully access the wifi signals;
the transmission module is further configured to be called and powered off by the network card master control module;
the master control module is further configured to call and power off the reception processing module after the routing device returns to the normal mode;
the reception processing module is further configured to be called and powered off by the master control module.

11. A method for implementing dynamic sleep and wakeup, wherein the method comprises:
selecting to enter into a sleep mode or a quasi-power-off mode according to an actual user access and traffic situation;
when a user requests to access a routing device which has entered into the sleep mode or the quasi-power-off mode, the routing device being woken up from the sleep mode to return to a normal mode or being powered on and recovered from the quasi-power-off mode to return to the normal mode according to an automatic wake-up/power-on command.

12. The method of claim 11, wherein, selecting the sleep mode or the quasi-power-off mode according to the actual user access and traffic situation specially comprises:
when there is no user access, or there is user access but there is no traffic, determining that the routing device is in an inactivity state;
when a duration of the inactivity state matches with a preset first detection time T1, selecting to enter into the sleep mode;
when a duration of the sleep mode matches with a preset second detection time T2, selecting to enter into the quasi-power-off mode.

13. The method of claim 12, wherein, returning to the normal mode based on the user request and according to the automatic wake-up/power-on command specifically comprises:
a network card device searching for and detecting wifi signals of the routing device, if no wifi signal is detected, sending the automatic wake-up/power-on command to the routing device;
the routing device being woken up from the sleep mode to return to the normal mode or being powered on and recovered from the quasi-power-off mode to return to the normal mode according to the received automatic wake-up/power-on command.

14. The device of claim 6, wherein, the master control module is further configured to perform an inactivity detection regularly according to a predetermined time, and control the routing device to enter into the sleep mode or the quasi-power-off mode.
